(19) United States
(12) Patent Application Publication
(10) Pub. No.: US 2006/0155893 A1
(43) Pub. Date: Jul. 13, 2006

(54) Methods and apparatus for sharing memory bandwidth

(75) Inventors: Kraig A. Bottemiller, Rochester, MN (US); Maulik K. Dave, Rochester, MN (US)

Correspondence Address: Robert Williams;IBM Corporation, Intellectual Property Law Dept. 917, 3605 Hwy. 52 North, Rochester, MN, 55901, US

(73) Assignee: International Business Machines Corporation, Armonk, NY (US)

(21) Appl. No.: 11/008,814

(22) Filed: Dec. 9, 2004

(51) Int. Cl. G06F 13/28

(52) U.S. Cl. 710/27

(57) ABSTRACT

In one aspect, a method is provided. The method includes the steps of (1) sharing memory bandwidth between a processor and one or more direct memory access (DMA) engines; (2) providing memory bandwidth to a DMA engine; (3) starting a data transfer between a memory and the DMA engine, via the memory bandwidth, based on a first preemption boundary value, wherein the data transfer may be preempted after transferring an amount of data equal to an integral multiple of the first preemption boundary value; (4) while transferring data between the memory and DMA engine, determining whether a request for memory bandwidth is received from the processor, wherein the processor is in an interrupt state; and (5) if so, adjusting the first preemption boundary value such that the adjusted preemption boundary value enables the processor to receive memory bandwidth sooner than the first preemption boundary value. Numerous other aspects are provided.

### FIELD OF THE INVENTION

The present invention relates generally to processors, and more particularly to methods and apparatus for sharing memory bandwidth.

### BACKGROUND

A conventional apparatus that shares memory bandwidth between a processor and a direct memory access (DMA) engine employs a preemption boundary value that is determined before operation of the apparatus (e.g., predetermined). During operation of the apparatus, data transferred between a memory and the processor or DMA engine, via the memory bandwidth, may be interrupted and/or preempted based on the predetermined preemption boundary value. However, such a predetermined preemption boundary value may not allow the processor to efficiently share memory bandwidth. Accordingly, improved methods and apparatus are desired for sharing memory bandwidth.

### SUMMARY OF THE INVENTION

In a first aspect of the invention, a first method is provided. The first method includes the steps of (1) sharing memory bandwidth between a processor and one or more direct memory access (DMA) engines; (2) providing memory bandwidth to a DMA engine; (3) starting a data transfer between a memory and the DMA engine, via the memory bandwidth, based on a first preemption boundary value, wherein the data transfer may be preempted after transferring an amount of data equal to an integral multiple of the first preemption boundary value; (4) while transferring data between the memory and DMA engine, determining whether a request for memory bandwidth is received from the processor, wherein the processor is in an interrupt state; and (5) if a request for memory bandwidth is received from the processor in the interrupt state, adjusting the first preemption boundary value such that the adjusted preemption boundary value enables the processor to receive memory bandwidth sooner than the first preemption boundary value.

In a second aspect of the invention, a second method is provided. The second method includes the steps of (1) sharing memory bandwidth between a processor and one or more direct memory access (DMA) engines; (2) providing memory bandwidth to a DMA engine; (3) starting a data transfer between a memory and the DMA engine, via the memory bandwidth, based on a first and second preemption boundary values, wherein the data transfer may be preempted after transferring an amount of data equal to an integral multiple of at least one of the first and second preemption boundary values and wherein the first preemption boundary value is smaller than the second preemption boundary value; (4) determining whether an amount of data equal to an integral multiple of at least one of the first and second preemption boundary values is transferred; (5) if an amount of data equal to an integral multiple of the first preemption boundary value is transferred, determining whether a request for memory bandwidth is received from a processor in an interrupt state; and (6) if a request for memory bandwidth is received from a processor in an interrupt state, providing memory bandwidth to the processor in the interrupt state.

In a third aspect of the invention, a first apparatus is provided. The first apparatus includes (1) a processor; (2) one or more DMA engines; (3) a memory; (4) an arbiter for coupling the processor and one or more DMA engines to the memory, thereby defining a memory bandwidth; and (5) logic coupled to the memory and arbiter. The logic is adapted to (a) share memory bandwidth between the processor and one or more direct memory access (DMA) engines; (b) provide memory bandwidth to a DMA engine; (c) start a data transfer between the memory and the DMA engine, via the memory bandwidth, based on the first preemption boundary value, wherein the data transfer may be preempted after transferring an amount of data equal to an integral multiple of the first preemption boundary value; (d) while transferring data between the memory and DMA engine, determine whether a request for memory bandwidth is received from the processor, wherein the processor is in an interrupt state; and (e) if a request for memory bandwidth is received from the processor in the interrupt state, adjust the first preemption boundary value such that the adjusted preemption boundary value enables the processor to receive memory bandwidth sooner than the first preemption boundary value.

In a fourth aspect of the invention, a second apparatus is provided. The second apparatus includes (1) a processor; (2) one or more direct memory access (DMA) engines; (3) a memory; (4) an arbiter for coupling the processor and one or more DMA engines to the memory, thereby defining a memory bandwidth; and (5) logic coupled to the memory and arbiter. The logic is adapted to (a) share memory bandwidth between the processor and one or more DMA engines; (b) provide memory bandwidth to a DMA engine; (c) start a data transfer between the memory and the DMA engine, via the memory bandwidth, based on a first and second preemption boundary values, wherein the data transfer may be preempted after transferring an amount of data equal to an integral multiple of at least one of the first and second preemption boundary values and wherein the first preemption boundary value is smaller than the second preemption boundary value; (d) determine whether an amount of data equal to an integral multiple of at least one of the first and second preemption boundary values is transferred; (e) if an amount of data equal to an integral multiple of the first preemption boundary value is transferred, determine whether a request for memory bandwidth is received from the processor in an interrupt state; and (f) if a request for memory bandwidth is received from the processor in an interrupt state, provide memory bandwidth to the processor in the interrupt state. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of an apparatus for sharing memory bandwidth in accordance with an embodiment of the present invention.

FIG. 2 illustrates a first exemplary method for sharing memory bandwidth in accordance with an embodiment of the present invention.

FIG. 3 illustrates a process flow of a second exemplary method for sharing memory bandwidth in accordance with an embodiment of the present invention.

### DETAILED DESCRIPTION

The present invention provides methods and apparatus for efficiently sharing memory bandwidth between a processor and one or more DMA engines. More specifically, data is transferred between a memory and the processor or one of the one or more DMA engines, via a memory bandwidth, based on a preemption boundary value. A data transfer may be interrupted and/or preempted when an amount of data transferred equals an integral multiple of the preemption boundary value. The present methods and apparatus may adjust the preemption boundary value during the data transfer such that memory bandwidth is shared, and consequently, data is transferred efficiently between the memory and the processor and/or between the memory and a DMA engine. Alternatively or additionally, the present methods and apparatus may employ a first and second preemption boundary values during the data transfer such that memory bandwidth is shared, and consequently, data is transferred efficiently between the memory and the processor and/or between the memory and a DMA engine.

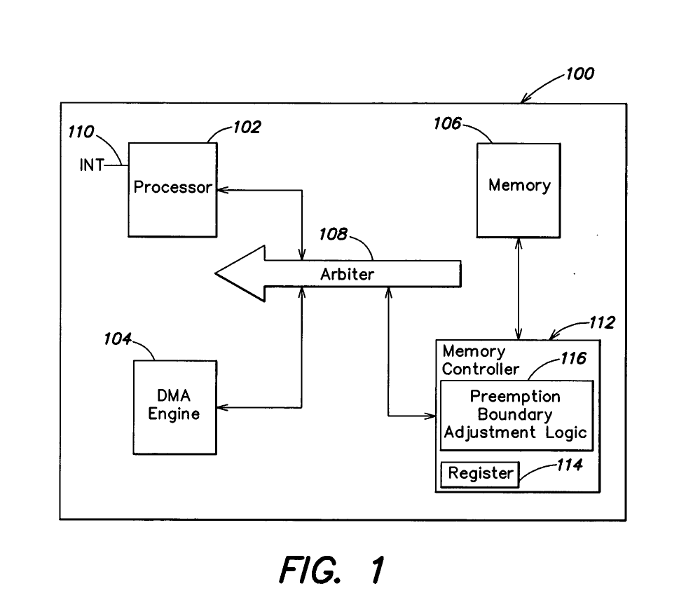

FIG. 1 is a block diagram of an apparatus for sharing memory bandwidth in accordance with an embodiment of the present invention. With reference to FIG. 1, the apparatus 100, which may be an integrated circuit (IC), such as a system on a chip (SOC), includes one or more processing units (e.g., one or more processors 102) (only one shown) and one or more direct memory access (DMA) engines 104 (only one shown) coupled to a memory 106 (e.g., DRAM or the like) via an arbiter 108. The arbiter 108 provides the processor 102 and one or more DMA engines 104 with access to the memory 106. Therefore, the arbiter 108 defines a bandwidth to the memory 106 which may be employed to transfer data between the memory 106 and the processor 102 or a DMA engine 104.

The processor 102 may access the memory 106, via the memory bandwidth, to execute an instruction (e.g., from an operating system (OS) or an application running on the apparatus 100) or read and write data. The processor 102 may operate in a user state in which the processor 102 executes instructions (e.g., application instructions), which may not urgently require access to the memory 106. In contrast, in response to receiving an interrupt signal (INT) on a processor input 110, the processor 102 operates in an interrupt (or exception) state, in which the processor 102 may switch tasks to execute instructions (e.g., OS instructions) that urgently require access to memory 106. A DMA engine 104 may also access the memory 106 of the apparatus 100 to load code or data into the memory 106.

To access the memory 106 via the memory bandwidth, the processor 102 or DMA engine 104 may request access to (e.g., control of) the arbiter 108. The apparatus 100 includes a memory controller 112 for sharing memory bandwidth (e.g., access to the arbiter). For example, the memory controller 112 may receive requests for memory bandwidth from a plurality of requestors (e.g., the processor 102 and one or more DMA engines 104). Priorities may be associated with such requests. For example, a processor 102 in an interrupt state urgently requires memory bandwidth (and therefore, access to the arbiter). Therefore, a request from such processor 102 may be assigned a higher priority than a request from a DMA engine 104 (although relative priorities associated with such requests may be different). The memory controller 112 is adapted to determine the highest-priority requestor and grant control of the arbiter 108 (e.g., arbitrate), thereby providing memory bandwidth, to such requester. The memory controller 112 includes any suitable combination of logic, registers, memory or the like. For example, the memory controller 112 may include one or more registers 114 (only one shown) for storing respective preemption boundary values. The preemption boundary value indicates when a data transfer between the memory 106 and a requester (e.g., a processor 102 or DMA engine 104) may be interrupted and/or preempted, such that the memory controller 112 may provide memory bandwidth for a request from another requester. In this manner, the preemption boundary value specifies boundaries at which the memory controller 112 will rearbitrate. Further, the memory controller 112 may include logic 116 (e.g., preemption boundary adjustment logic) adapted to adjust the preemption boundary value such that memory bandwidth may be shared efficiently, and consequently, data may be transferred efficiently between the memory 106 and the processor 102 and between the memory and a DMA engine.

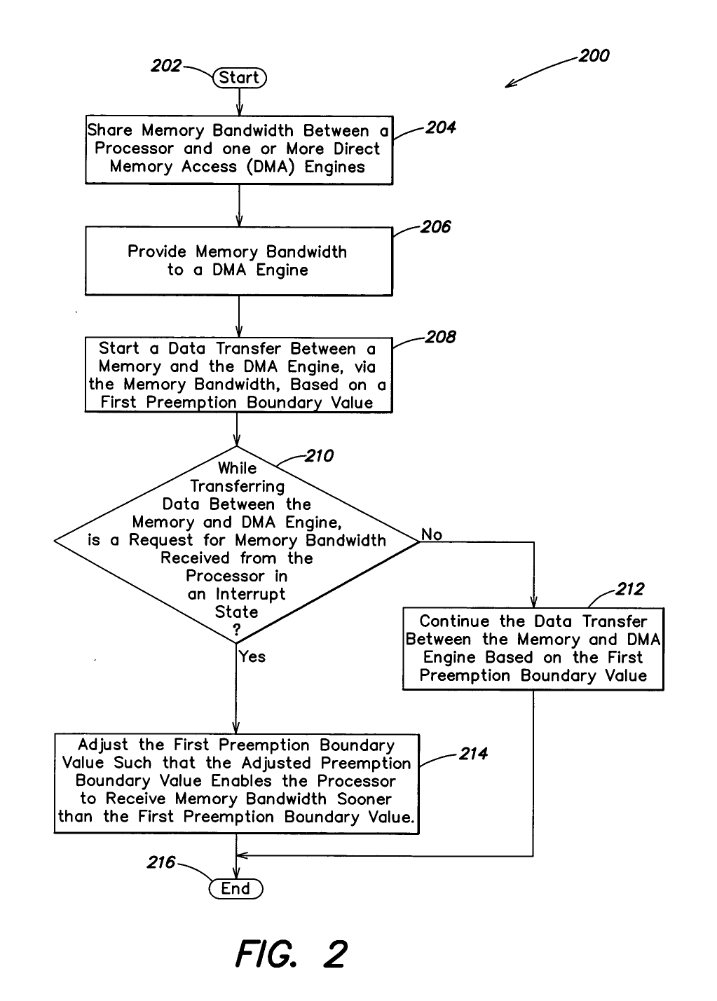

The operation of the apparatus 100 for sharing memory bandwidth is now described with reference to FIG. 1 and with reference to FIG. 2 which illustrates a first exemplary method for sharing memory bandwidth in accordance with an embodiment of the present invention. With reference to FIG. 2, in step 202, the method 200 begins. In step 204, memory bandwidth is shared between a processor and one or more direct memory access (DMA) engines. More specifically, as stated, the apparatus 100 includes an arbiter 108 that provides the processor 102 and one or more DMA engines 104 with access to the memory 106. Therefore, the arbiter 108 defines a bandwidth to the memory 106 which may be employed to transfer data between the memory 106 and the processor 102 or a DMA engine 104. In this manner, the memory bandwidth is shared between the processor 102 and one or more DMA engines 104.

In step 206, memory bandwidth is provided to a DMA engine. More specifically, in response to receiving requests from one or more DMA engines 104 and/or processor 102, the memory controller 112 may determine a request from one of the DMA engines 104 is of a higher priority than requests from other requestors, such as the processor 102 and remaining DMA engines 104, and therefore, determine the DMA engine is a higher priority requestor of memory bandwidth than the processor 102 and remaining DMA engines 104. Therefore, the memory controller 112 provides memory bandwidth to the DMA engine 104.

In step 208, a data transfer is started between a memory and the DMA engine, via the memory bandwidth, based on a first preemption boundary value, wherein the data transfer may be interrupted and preempted after transmitting an amount of data equal to an integral multiple of the first preemption boundary value. Bursts of data may need to be transferred between the memory 106 and the DMA engine 104. For example, 1024 bytes of data may need to be transferred between the memory 106 and the DMA engine 104 (although a larger or smaller amount of data may need to be transferred). The larger a portion of such burst that is transferred between the memory 106 and DMA engine 104 without preemption by another request (e.g., a higher-priority request), the more efficient the DMA data transfer. Therefore, the first preemption boundary value, which is stored in the register 114 of the memory controller 112, is chosen such that a large portion of the DMA burst may be transferred without interruption and/or preemption, which may result in the best DMA performance. For example, the first preemption boundary value may be 512 bytes (although a larger or smaller value may be employed). Therefore, once a data transfer between the memory 106 and DMA engine 104 commences, the data transfer may not be interrupted and/or preempted until at least an integral multiple of the first preemption boundary value (e.g., 1×512 bytes) of data have been transferred. However, although the first preemption boundary value may enable efficient data transfer between the memory 106 and DMA engine 104, such value may not provide memory bandwidth to a request received by a higher-priority requester, such as a processor in an interrupt state, until at least 512 bytes of data are transferred between the memory 106 and DMA engine 104. Consequently, maintaining the first preemption boundary value during operation of the apparatus 100 may result in an inefficient sharing of memory bandwidth (e.g., with the processor 102).

Therefore, in step 210, while transferring data between the memory 102 and DMA engine 104, it is determined whether a request for memory bandwidth is received from the processor 102, wherein the processor 102 is in an interrupt state. More specifically, while transferring data between the memory 106 and DMA engine 104, the apparatus 100 may receive a request for memory bandwidth from a higher priority requester than the DMA engine 104, such as the processor 102 in an interrupt state. The memory controller 112 may determine whether such request is received.

If, in step 210, it is determined a request for memory bandwidth is not received from the processor 102 in an interrupt state, step 212 is performed. In step 212, the data transfer between the memory 106 and DMA engine 104 continues based on the first preemption boundary value. Therefore, the data transfer between the memory 106 and DMA engine 104 may only be interrupted and/or preempted after transmitting an amount of data equal to an integral multiple of the first preemption boundary value. In the example above, the data transfer may only be interrupted and/or preempted after 512 bytes of data are transferred, because when an amount of data equal to the next integral multiple of the first preemption boundary value (e.g., 1024 bytes) is transferred, the DMA burst is complete. Thereafter, step 216 is performed. In step 216, the method 200 ends.

Alternatively, if, in step 210, it is determined a request for memory bandwidth is received from the processor 102 in an interrupt state, step 214 is performed. In step 214, the first preemption boundary value is adjusted such that the adjusted preemption boundary value enables the processor 102 to receive memory bandwidth sooner than the first preemption boundary value. For example, the first preemption boundary value is adjusted such that the adjusted preemption boundary value enables data transfer between the memory 106 and the DMA engine 104 to be interrupted and/or preempted sooner. More specifically, the first preemption boundary value may be reduced. Logic 116 (e.g., preemption boundary adjustment logic) adjusts the first preemption boundary value. The adjusted preemption boundary value may be stored in the memory controller register 114.

In this manner, the adjusted preemption boundary value may be employed to reduce the amount of data that must be transferred between the memory 106 and a requester (e.g., DMA engine 104) before such data transfer may be interrupted and/or preempted. Consequently, the memory controller 112 may provide memory bandwidth to a request from another requester, such as the processor in interrupt state that may be executing an instruction which urgently requires memory bandwidth, sooner, which may result in the best processor performance. In this manner, the memory controller 112 may provide rearbitration within a DMA burst.

Additionally, once the first preemption boundary value is adjusted to the adjusted preemption boundary value, the data transfer between the memory 106 and the DMA engine 104 may continue based on the adjusted preemption boundary. More specifically, although the data transfer between the memory 106 and DMA engine 104 is started based on a first preemption boundary, once the preemption boundary is adjusted during the transfer, the data transfer between the memory 106 and DMA engine 104 continues based on the adjusted preemption boundary. Therefore, the data transfer may be interrupted and/or preempted after transmitting an amount of data equal to an integral multiple of the adjusted preemption boundary value. For example, after the apparatus 100 transmits the first 32 bytes of the 1024 byte DMA burst between the memory 106 and DMA engine 104, the memory controller 112 may receive a request for memory bandwidth from the processor 102 in an interrupt state, and in response, adjust the first preemption boundary value of 512 bytes to an adjusted preemption boundary value of 128 bytes (although a larger or smaller adjusted preemption boundary value may be employed). Consequently, remaining data of the 1024 byte DMA burst is transferred based on the adjusted preemption boundary value, and therefore, may be interrupted and/or preempted after transmitting an amount of data equal to an integral multiple of 128 bytes. For example, the data transfer between the memory 106 and DMA engine 104 may be interrupted and/or preempted after 128 bytes of data is transmitted between the memory 106 and DMA engine 104. In contrast, if the data transfer was still based on the first preemption boundary value, the data transfer may not be interrupted and/or preempted until 512 bytes of data was transferred. In this manner, memory latency may be reduced (e.g., for the processor request).

Additionally, after interrupting the data transfer based on the adjusted preemption boundary value, the memory controller 112 may provide control of the arbiter 108, and consequently, memory bandwidth, to the processor 102 in an interrupt state (e.g., after determining the processor request is the highest-priority request for memory bandwidth). In this manner, the data transfer between the memory 106 and DMA engine 104 may be preempted. Data is transferred between the memory 106 and processor 102 via the memory bandwidth based on the adjusted preemption boundary value. In some embodiments, 32 bytes of data may be transmitted between the memory 106 and processor 102 (although a larger or smaller amount of data may be transferred).

Additionally, thereafter, the adjusted preemption boundary value (e.g., first adjusted preemption boundary value) may be adjusted to a second adjusted preemption boundary value, such that the second adjusted preemption boundary value enables a DMA engine to transmit more data without an interruption and/or preemption than the first adjusted preemption boundary value. For example, the adjusted preemption boundary value may be increased. In one embodiment, the second adjusted preemption boundary value may be the first preemption boundary value (although a larger or smaller value may be employed). For example, the adjusted preemption boundary value may be adjusted from 128 bytes to a second adjusted preemption boundary value of 512 bytes.

The apparatus 100 may provide memory bandwidth to a DMA engine 104, such as the DMA engine 104 whose DMA burst was interrupted and preempted (e.g., after the memory controller 112 determines a request from such DMA engine 104 for memory bandwidth is the highest-priority request). The data transfer (e.g., interrupted and preempted data transfer) between the memory 106 and such DMA engine 104 may commence (e.g., in this case continue) based on the second adjusted preemption boundary value, which as stated, enables the DMA engine to transfer more data without an interruption than the first adjusted preemption boundary value. In this manner, a large amount of data may be transferred between the memory 106 and DMA engine 104 without interruption and/or preemption, which results in efficient data transfer between the memory 106 and DMA engine 104.

Thereafter, step 216 is performed. In step 216, the method 200 ends.

Through use of the method 200 for sharing memory bandwidth, a preemption boundary value employed during the data transfer may be adjusted (e.g., dynamically) during operation of the apparatus 100 such that memory bandwidth is shared efficiently, and consequently, data is transferred efficiently between the memory and the processor and/or between the memory and a DMA engine. More specifically, the preemption boundary value is adjusted such that a large amount of data may be transferred between the memory 106 and DMA engine 104 without interruption and/or preemption when the DMA engine 104 is the highest-priority requester, thereby enabling efficient data transfer between the memory 106 and DMA engine 104. However, if a higher-priority request (e.g., from a processor in an interrupt state) for memory bandwidth is received during the DMA transfer, the preemption boundary value is adjusted such that the adjusted preemption boundary value enables the processor to receive memory bandwidth sooner than with the previous preemption boundary value.

In this manner, the present methods and apparatus avoid a disadvantage (e.g., inefficient data transfer between the memory 106 and a DMA engine 104) of maintaining a low preemption boundary value and a disadvantage (e.g., inefficient data transfer between the memory 106 and a processor 102) of maintaining a high preemption boundary value during operation of the apparatus 100.

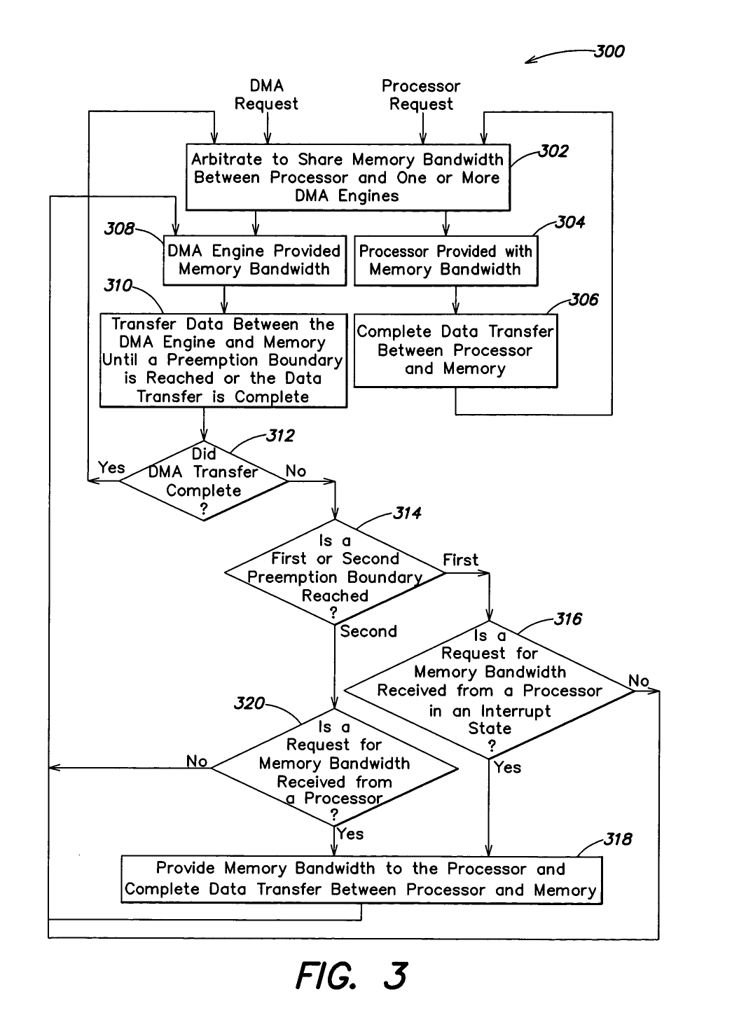

Alternatively, the present methods and apparatus may employ a first and second preemption boundary values during a data transfer such that memory bandwidth is shared, and consequently, data is transferred efficiently between the memory and the processor and/or between the memory and a DMA engine. FIG. 3 illustrates a process flow of a second exemplary method for sharing memory bandwidth in accordance with an embodiment of the present invention. An apparatus similar to the apparatus 100 for sharing memory bandwidth may be employed to perform the second exemplary method. In some embodiments, such apparatus may or may not include the preemption boundary adjustment logic 116. With reference to FIG. 3, in step 302, the process 300 begins. In step 302, the memory controller 112 may share memory bandwidth between one or more processors 102 and one or more direct memory access (DMA) engines 104 by arbitrating. More specifically, the memory controller 112 may receive a plurality of requests (e.g., from requesters, such as the one or more processors 102 and/or one or more DMA engines 104) and determine the highest-priority requestor.

If, in step 302, the memory controller 102 determines a processor is the highest priority requester, step 304 may be performed. In step 304, the processor 102 may be provided with memory bandwidth. More specifically, the memory controller 112 may grant control of the arbiter 108, thereby providing memory bandwidth, to such processor 102. Consequently, the apparatus 100 may transfer data between the processor 102 and memory 106. Thereafter, step 306 may be performed. In step 306, the data transfer between the processor 102 and memory 106 may complete. Therefore, the processor 102 may no longer require memory bandwidth. Thus, thereafter, step 302 may be performed, in which the memory controller 112 may arbitrate (e.g., rearbitrate) to share memory bandwidth.

Alternatively, if, in step 302, the memory controller 112 determines a DMA engine 104 is the highest priority requester, step 308 may be performed. In step 308, the memory controller 112 may grant control of the arbiter 108, thereby providing memory bandwidth, to such DMA engine 104. Therefore, the apparatus 100 may begin to transfer data between the DMA engine 104 and memory 106. As stated, a large amount of data may need to be transferred between the DMA engine 104 and memory 106. For example, 1024 bytes of data may need to transferred (although a larger or smaller amount of data may need to be transferred). Further, the larger a portion of such data transferred between the memory 106 and DMA engine 104 without preemption by another request (e.g., a higher-priority request) is, the more efficient the data transfer. Thereafter, step 310 is performed. In step 310, data may be transferred between the DMA engine 104 and memory 106 until a preemption boundary (e.g., a first and/or second preemption boundary) is reached or such data transfer completes. As stated, a preemption boundary value indicates when a data transfer between the memory 106 and a requestor (e.g., a processor 102 or DMA engine 104) may be interrupted and/or preempted, such that the memory controller 112 may provide memory bandwidth for a request from another requester. In this manner, a first portion of such data transfer or the entire data transfer may complete. For example, an entire data transfer between the DMA engine 104 and memory 106 may complete before transferring an amount of data equal to an integral multiple of a preemption boundary value.

Once the data transfer has been interrupted or completes, in step 312, it is determined whether the data transfer between the DMA engine 104 and memory 106 completes. If, in step 312, it is determined that the data transfer between the DMA engine 104 and memory 106 (e.g., DMA transfer) completes, the DMA engine 104 may no longer require memory bandwidth. Thus, thereafter, step 302 may be performed, in which the memory controller 112 may arbitrate (e.g., rearbitrate) to share memory bandwidth.

Alternatively, if, in step 312, it is determined the DMA transfer does not complete, a preemption boundary may have been reached during the data transfer. More specifically, the memory controller 112 may determine an amount of data equal to an integral multiple of a first and/or second preemption boundary, which is larger than the first preemption boundary, is transferred, and therefore, a preemption boundary is reached. In step 314, it is determined an amount of data equal to an integral multiple of a first or second preemption boundary is reached. For example, the memory controller 112 may determine whether the first or second preemption boundary is reached. More specifically, the memory controller 112 may determine whether an amount of data equal to an integral multiple of the first or second preemption boundary value is transferred. If, in step 314, it is determined that a first preemption boundary is reached, step 316 may be performed. It should be noted that if, in step 314, the first and second preemption boundaries are reached, step 316 is performed. In step 316, it is determined whether a request for memory bandwidth from a processor in an interrupt state is received. More specifically, the memory controller 112 may determine whether a processor 102 in an interrupt state requires memory bandwidth. If it is determined, in step 316, that a request is received from a processor in an interrupt state, the data transfer between the DMA engine 104 and memory 106 may be preempted. More specifically, step 318 may be performed.

In step 318, memory bandwidth is provided to the processor 102 and a data transfer between such processor 102 and the memory 106 completes. More specifically, the memory controller 112 may provide the processor 102 in an interrupt state (e.g., a processor that urgently requires memory bandwidth) with memory bandwidth, thereby enabling a data transfer between such processor 102 and the memory 106 to complete. In this manner a DMA transfer may be preempted by a request for memory bandwidth from a processor in an interrupt state. Once the data transfer between such processor 102 and the memory 106 completes, the processor 102 may no longer require access to memory bandwidth. Thus, thereafter, step 308 may be performed, in which the DMA engine 104 is provided with memory bandwidth. In this manner, the DMA transfer which was interrupted and preempted when such transfer reached the first preemption boundary may continue (e.g., until completion or another preemption boundary is reached).

Alternatively, if, in step 316, it is determined a request for memory bandwidth is not received from a processor in an interrupt state, a processor 102, which may be a higher priority requester than a DMA engine 104, may not require memory bandwidth. Thus, thereafter, step 308 may be performed, in which, as stated, the DMA engine 104 is provided with memory bandwidth and the interrupted DMA transfer may continue (e.g., until completion or another preemption boundary is reached).

Alternatively and/or additionally, if in step 314, it is determined that a second preemption boundary is reached, step 320 may be performed. However, as stated, it should be noted that if, in step 314, the first and second preemption boundaries are reached, step 316 is performed. In step 320, it is determined whether a request for memory bandwidth is received from a processor 102. More specifically, the memory controller 112 may determine whether a processor 102 requires memory bandwidth. If, in step 320, it is determined that a request is received from a processor 102, the data transfer between the DMA engine 104 and memory 106 may be preempted. More specifically, step 318 may be performed. As stated, in step 318, memory bandwidth is provided to the processor 102 and a data transfer between such processor 102 and the memory 106 completes. In this manner a DMA transfer may be preempted by request for memory bandwidth from a processor 102.

However, if, in step 320, it is determined that a request from a processor 102 for memory bandwidth is not received, a processor 102 may not require memory bandwidth. Thus, thereafter, step 308 may be performed, in which, as stated, the DMA engine 104 is provided with memory bandwidth and the interrupted DMA transfer may continue (e.g., until completion or another preemption boundary is reached).

Through use of the method 300 for sharing memory bandwidth, first and second preemption boundary values may be employed during a data transfer such that memory bandwidth is shared efficiently, and consequently, data is transferred efficiently between the memory 106 and the processor 102 and/or between the memory 106 and a DMA engine 104. More specifically, the first and second preemption boundary values are employed such that a large amount of data may be transferred between the memory 106 and DMA engine 104 without preemption when the DMA engine 104 is the highest-priority requester, thereby enabling efficient data transfer between the memory 106 and DMA engine 104. However, if a higher-priority request (e.g., from a processor in an interrupt state) for memory bandwidth is received during the DMA transfer, the transfer between the DMA engine 104 and memory 106 may be preempted after an integral multiple of the first preemption boundary value of data is transferred. Consequently, the apparatus 100 enables the processor 102 to receive memory bandwidth sooner than with single larger preemption boundary value. Further, the apparatus 100 may not preempt a DMA transfer until a request for memory bandwidth from a higher priority requester is received.

The first and second preemption boundary values may be chosen such that a large portion (or all) of a DMA transfer may complete without preemption (based on the second preemption boundary value) as long as a request from a processor in an interrupt state is not received. However, if a request for memory bandwidth is received from a processor in an interrupt state, the DMA transfer may be preempted (based on the first preemption boundary value) sooner than when such request is not received. For example, the second preemption boundary value may be larger than the first preemption boundary value. In this manner, the present methods and apparatus avoid a disadvantage (e.g., inefficient data transfer between the memory 106 and a DMA engine 104) of maintaining a low preemption boundary value and a disadvantage (e.g., inefficient data transfer between the memory 106 and a processor 102) of maintaining a high preemption boundary value during operation of the apparatus 100.

The foregoing description discloses only exemplary embodiments of the invention. Modifications of the above disclosed apparatus and methods which fall within the scope of the invention will be readily apparent to those of ordinary skill in the art. For instance, although in some embodiments, the preemption boundary adjustment logic 116 and register 114 for storing a preemption boundary adjustment value are included in the memory controller 112, in other embodiments, the preemption boundary adjustment logic 116 and/or register 114 for storing the preemption boundary adjustment value may be located elsewhere in the apparatus 100. Further, although the present methods and apparatus are described above as sharing memory bandwidth between a processor and one or more DMA engines, in a broader aspect, the present methods and apparatus may share memory bandwidth efficiently between a plurality of any requesters for memory bandwidth. In some embodiments, the preemption boundary value may be selected such that a DMA transfer may be interrupted and/or preempted up to eight times (although the value may be selected such that the DMA transfer may be interrupted and/or preempted a larger or smaller number of times). In some embodiments, the memory controller 112 may toggle the preemption boundary value between a maximum value (e.g., 256 bytes) for maximizing memory bandwidth provided to DMA transfers while the processor is in the user state, and a minimum value (e.g., 64 bytes) for reducing processor latency while the processor 102 is in the interrupt state. Although the second exemplary method employs two preemption boundary values, a larger or smaller number of preemption boundary values may be employed.

Accordingly, while the present invention has been disclosed in connection with exemplary embodiments thereof, it should be understood that other embodiments may fall within the spirit and scope of the invention, as defined by the following claims.

The invention claimed is:

1. A method, comprising:
sharing memory bandwidth between a processor and one or more direct memory access (DMA) engines;
providing memory bandwidth to a DMA engine;
starting a data transfer between a memory and the DMA engine, via the memory bandwidth, based on a first preemption boundary value, wherein the data transfer may be preempted after transferring an amount of data equal to an integral multiple of the first preemption boundary value;
while transferring data between the memory and DMA engine, determining whether a request for memory bandwidth is received from the processor, wherein the processor is in an interrupt state; and
if a request for memory bandwidth is received from the processor in the interrupt state, adjusting the first preemption boundary value such that the adjusted preemption boundary value enables the processor to receive memory bandwidth sooner than the first preemption boundary value.

2. The method of claim 1 wherein providing memory bandwidth to a DMA engine includes:
determining a DMA engine is a higher priority requester of memory bandwidth than the processor and remaining DMA engines; and
thereafter, providing memory bandwidth to the DMA engine.

3. The method of claim 1 wherein adjusting the first preemption boundary value such that the adjusted preemption boundary value enables the processor to receive memory bandwidth sooner than the first preemption boundary value includes reducing the first preemption boundary value.

4. The method of claim 1 further comprising, based on the adjusted preemption boundary, continuing the data transfer between the memory and the DMA engine, via the memory bandwidth.

5. The method of claim 4 wherein, based on the adjusted preemption boundary, continuing the data transfer between the memory and the DMA engine, via the memory bandwidth, includes continuing to transfer data between the memory and the DMA engine, via the memory bandwidth, until an amount of data equal to an integral multiple of the adjusted preemption boundary is transferred.

6. The method of claim 4 further comprising:
providing memory bandwidth to the processor; and
transferring data between the memory and the processor, via the memory bandwidth, based on the adjusted preemption boundary value.

7. The method of claim 6 wherein providing memory bandwidth to the processor includes:
determining the processor is a higher priority requester of memory bandwidth than the one or more DMA engines; and
thereafter, providing memory bandwidth to the processor.

8. The method of claim 6 further comprising:
adjusting the adjusted preemption boundary value to a second adjusted preemption boundary value such that the second adjusted preemption boundary value enables the DMA engine to transfer more data without a preemption than the adjusted preemption boundary value;
providing memory bandwidth to the DMA engine; and
based on the second adjusted preemption boundary value, continuing the data transfer between the memory and DMA engine.

9. The method of claim 8 wherein the second adjusted preemption boundary value is the first preemption boundary value.

10. The method of claim 8 wherein providing memory bandwidth to the processor includes:
determining the DMA engine is a higher priority requester of memory bandwidth than the processor and remaining DMA engines; and
thereafter, providing memory bandwidth to the processor.

11. The method of claim 8 wherein adjusting the adjusted preemption boundary value to a second adjusted preemption boundary value includes increasing the adjusted preemption boundary value.

12. An apparatus, comprising:
a processor;
one or more direct memory access (DMA) engines;
a memory;
an arbiter for coupling the processor and one or more DMA engines to the memory, thereby defining a memory bandwidth; and
logic, coupled to the memory and arbiter, and adapted to:
share memory bandwidth between the processor and one or more DMA engines;
provide memory bandwidth to a DMA engine;
start a data transfer between the memory and the DMA engine, via the memory bandwidth, based on a first preemption boundary value, wherein the data transfer may be preempted after transferring an amount of data equal to an integral multiple of the first preemption boundary value;
while transferring data between the memory and DMA engine, determine whether a request for memory bandwidth is received from the processor, wherein the processor is in an interrupt state; and
if a request for memory bandwidth is received from the processor in the interrupt state, adjust the first preemption boundary value such that the adjusted preemption boundary value enables the processor to receive memory bandwidth sooner than the first preemption boundary value.

13. The apparatus of claim 12 wherein the logic is further adapted to:
determine the DMA engine is a higher priority requester of memory bandwidth than the processor and remaining DMA engines; and
thereafter, provide memory bandwidth to the DMA engine.

14. The apparatus of claim 12 wherein the logic is further adapted to reduce the first preemption boundary value.

15. The apparatus of claim 12 wherein the logic is further adapted to, based on the adjusted preemption boundary, continue the data transfer between the memory and the DMA engine, via the memory bandwidth.

16. The apparatus of claim 15 wherein the logic is further adapted to continue to transfer data between the memory and the DMA engine, via the memory bandwidth, until an amount of data equal to an integral multiple of the adjusted preemption boundary is transferred.

17. The apparatus of claim 15 wherein the logic is further adapted to:
provide memory bandwidth to the processor; and
transfer data between the memory and the processor, via the memory bandwidth, based on the adjusted preemption boundary value.

18. The apparatus of claim 17 wherein the logic is further adapted to:
determine the processor is a higher priority requestor of memory bandwidth than the one or more DMA engines; and
thereafter, provide memory bandwidth to the processor.

19. The apparatus of claim 17 wherein the logic is further adapted to:
adjust the adjusted preemption boundary value to a second adjusted preemption boundary value such that the second adjusted preemption boundary value enables the DMA engine to transfer more data without a preemption than the adjusted preemption boundary value;
provide memory bandwidth to the DMA engine; and
based on the second adjusted preemption boundary value, continue the data transfer between the memory and DMA engine.

20. The apparatus of claim 19 wherein the second adjusted preemption boundary value is the first preemption boundary value.

21. The apparatus of claim 19 wherein the logic is further adapted to:
determine the DMA engine is a higher priority requestor of memory bandwidth than the processor and remaining DMA engines; and
thereafter, provide memory bandwidth to the processor.

22. The apparatus of claim 19 wherein the logic is further adapted to increase the adjusted preemption boundary value.

23. A method, comprising:
sharing memory bandwidth between a processor and one or more direct memory access (DMA) engines;
providing memory bandwidth to a DMA engine;
starting a data transfer between a memory and the DMA engine, via the memory bandwidth, based on a first and second preemption boundary values, wherein the data transfer may be preempted after transferring an amount of data equal to an integral multiple of at least one of the first and second preemption boundary values and wherein the first preemption boundary value is smaller than the second preemption boundary value;
determining whether an amount of data equal to an integral multiple of at least one of the first and second preemption boundary values is transferred;
if an amount of data equal to an integral multiple of the first preemption boundary value is transferred, determining whether a request for memory bandwidth is received from a processor in an interrupt state; and
if a request for memory bandwidth is received from a processor in an interrupt state, providing memory bandwidth to the processor in the interrupt state.

24. The method of claim 23 further comprising, if a request for memory bandwidth is received from a processor in an interrupt state, transferring data between the memory and the processor in the interrupt state.

25. The method of claim 24 further comprising:
upon completion of transferring data between the memory and the processor in the interrupt state, providing memory bandwidth to the DMA engine; and
continuing the data transfer between the memory and DMA engine based on the first and second preemption boundary values.

26. The method of claim 23 further comprising, if a request for memory bandwidth is not received from a processor in an interrupt state:
providing memory bandwidth to the DMA engine; and
continuing the data transfer between the memory and the DMA engine based on the first and second preemption boundary values.

27. The method of claim 23 further comprising:
if an amount of data equal to an integral multiple of the second preemption boundary value, which is not an integral multiple of the first preemption boundary value, is transferred, determining whether a request for memory bandwidth is received from a processor; and
if a request for memory bandwidth is received from a processor, providing memory bandwidth to the processor.

28. The method of claim 27 further comprising, if a request for memory bandwidth is received from a processor, transferring data between the memory and the processor.

29. The method of claim 28 further comprising:
upon completion of transferring data between the memory and the processor, providing memory bandwidth to the DMA engine; and
continuing the data transfer between the memory and DMA engine based on the first and second preemption boundary values.

30. The method of claim 27 further comprising, if a request for memory bandwidth is not received from a processor:
providing memory bandwidth to the DMA engine; and
continuing the data transfer between the memory and the DMA engine based on the first and second preemption boundary values.

31. An apparatus, comprising:
a processor;
one or more direct memory access (DMA) engines;
a memory;
an arbiter for coupling the processor and one or more DMA engines to the memory, thereby defining a memory bandwidth; and
logic, coupled to the memory and arbiter, and adapted to:
share memory bandwidth between the processor and one or more DMA engines;
provide memory bandwidth to a DMA engine;
start a data transfer between the memory and the DMA engine, via the memory bandwidth, based on a first and second preemption boundary values, wherein the data transfer may be preempted after transferring an amount of data equal to an integral multiple of at least one of the first and second preemption boundary values and wherein the first preemption boundary value is smaller than the second preemption boundary value;
determine whether an amount of data equal to an integral multiple of at least one of the first and second preemption boundary values is transferred;
if an amount of data equal to an integral multiple of the first preemption boundary value is transferred, determine whether a request for memory bandwidth is received from the processor in an interrupt state; and
if a request for memory bandwidth is received from the processor in an interrupt state, provide memory bandwidth to the processor in the interrupt state.

32. The apparatus of claim 31 wherein the logic is further adapted to, if a request for memory bandwidth is received from the processor in an interrupt state, transfer data between the memory and the processor in the interrupt state.

33. The apparatus of claim 32 wherein the logic is further adapted to:
upon completion of transferring data between the memory and the processor in the interrupt state, provide memory bandwidth to the DMA engine; and
continue the data transfer between the memory and DMA engine based on the first and second preemption boundary values.

34. The apparatus of claim 31 wherein the logic is further adapted to, if a request for memory bandwidth is not received from the processor in an interrupt state:
provide memory bandwidth to the DMA engine; and
continue the data transfer between the memory and the DMA engine based on the first and second preemption boundary values.

35. The apparatus of claim 31 wherein the logic is further adapted to:
if an amount of data equal to an integral multiple of the second preemption boundary value, which is not an integral multiple of the first preemption boundary value, is transferred, determine whether a request for memory bandwidth is received from the processor; and
if a request for memory bandwidth is received from the processor, provide memory bandwidth to the processor.

36. The apparatus of claim 35 wherein the logic is further adapted to, if a request for memory bandwidth is received from the processor, transfer data between the memory and the processor.

37. The apparatus of claim 36 wherein the logic is further adapted to:
upon completion of transferring data between the memory and the processor, provide memory bandwidth to the DMA engine; and
continue the data transfer between the memory and DMA engine based on the first and second preemption boundary values.

38. The apparatus of claim 35 wherein the logic is further adapted to, if a request for memory bandwidth is not received from a processor:
provide memory bandwidth to the DMA engine; and
continue the data transfer between the memory and the DMA engine based on the first and second preemption boundary values.
